(19) United States
(12) Patent Application Publication
(10) Pub. No.: US 2024/0385586 A1
(43) Pub. Date: Nov. 21, 2024

(54) Testing a Configuration of at Least One Component of an Automation System and Automation System

(71) Applicant: Siemens Aktiengesellschaft, München (DE)

(72) Inventors: Stefan Pyka, Markt Schwaben (DE); Rainer Falk, Erding (DE); Axel Pfau, Freiburg (DE); Christian Peter Feist, München (DE); Franz Sperl, Oberviechtach (DE); Daniel Schneider, München (DE)

(73) Assignee: Siemens Aktiengesellschaft, München (DE)

(21) Appl. No.: 18/564,910

(22) PCT Filed: May 11, 2022
(86) PCT No.: PCT/EP2022/062817

§ 371 Date: Nov. 28, 2023

(30) Foreign Application Priority Data
May 28, 2021 (DE) 10 2021 205 483.8
Jul. 8, 2021 (EP) 21184487.3

(51) Int. Cl. G05B 19/4093

(52) U.S. Cl. CPC G05B 19/4093; G05B 2219/33216

(57) ABSTRACT

Various embodiments of the teachings herein include methods and/or systems for checking a configuration of at least one component of an automation installation. An example method includes checking configuration data of the at least one component for admissibility using a checking server different from the at least one component.

### CROSS-REFERENCE TO RELATED APPLICATIONS

This application is a U.S. National Stage Application of International Application No. PCT/EP2022/062817 filed May 11, 2022, which designates the United States of America, and claims priority to EP application Ser. No. 21/184,487.3 filed on Jul. 8, 2021 and DE Application No. 10 2021 205 483.8 filed May 28, 2021, the contents of which are hereby incorporated by reference in their entirety.

### TECHNICAL FIELD

The present disclosure relates to automation installations. Various embodiments of the teachings herein include methods and/or systems for checking a configuration of at least one component of an automation installation, and automation installations having at least one component.

### BACKGROUND

Industrial installations, in particular automation installations, commonly have components that often need to be reconfigured. This is because for example the network infrastructure changes frequently due to the addition of new components, or components having changed operating tasks are used in an automation installation. This may be the case in particular with flexible production, that is to say in Industry 4.0. This is also referred to there as “plug-and-produce”. The operating sequence and accordingly the operating instructions for components may also change in automation installations, which requires the components to be reconfigured.

It is known, when reconfiguring components, to adopt configuration data in relation to the new configuration without a check. Adopting configuration data in this way for new configurations of components however entails a significant risk for automation installations. This is because erroneous configuration data or configuration data manipulated by an attacker, even in relation to only a few components, may lead to incorrect behavior of the entire automation installation, which, in extreme cases, results in the failure of the entire automation installation and/or the destruction of individual or all components of the automation installation. In addition, in the case of an incorrect configuration of components or a configuration of components manipulated by an attacker, sensitive data may also be released or siphoned off in a targeted manner.

### SUMMARY

Teachings of the present disclosure provide improved methods for checking a configuration of a component of an automation installation, which method enables in particular improved operational and/or information security, in particular with regard to an authenticity and integrity of data, of the automation installation. For example, some embodiments include a method for checking (CHAPP) a configuration of at least one component (COMP1, COMP2, COMP3) of an automation installation (MAN), in which configuration data (NECO) of the at least one component (COMP1, COMP2, COMP3) are checked for admissibility by way of a checking server (CHESER) different from the at least one component (COMP1, COMP2, COMP3).

In some embodiments, the configuration data (NECO) are checked on the basis of a current operating mode of the automation installation (MAN).

In some embodiments, the operating mode is a production mode and/or a maintenance mode and/or a test mode.

In some embodiments, the operating mode indicates an automated process of the automation installation (MAN), in particular a process from a set of a first production process or a second production process different from the first.

In some embodiments, at least the first and the second production process differ from one another in terms of a product of the first and second production processes and preferably additionally in terms of product-related parameters of the first and second production process.

In some embodiments, the check (CHAPP) on the configuration additionally takes place depending on: an IT infrastructure of the automation installation (MAN) and/or information about the at least one component (COMP1, COMP2, COMP3) of the automation installation (MAN) and/or a result of a plausibility check on the configuration data (NECO) of the at least one component (COMP1, COMP2, COMP3) and/or a whitelist for admissible configuration data (NECO) of the at least one component (COMP1, COMP2, COMP3) and/or a blacklist for inadmissible configuration data (NECO) of the at least one component (COMP1, COMP2, COMP3) and/or at least one cryptographic signature.

In some embodiments, the automation installation, in addition to the at least one component (COMP1, COMP2, COMP3), has at least one second or multiple components (COMP2, COMP3) and in which configuration data (NECO) of the second or the multiple components (COMP2, COMP3) are subjected to a check for admissibility by way of the at least one checking server (CHESER) and in which information is used in the check on the second or the multiple additional components (COMP2, of COMP3) the automation installation when the configuration data of the at least one component (COMP1, COMP2, COMP3) are checked.

As another example, some embodiments include an automation installation, designed to carry out one or more of the methods as described herein, comprising at least one component (COMP1, COMP2, COMP3) having a memory containing configuration data (NECO) and a checking server (CHESER) different from the at least one component (COMP1, COMP2, COMP3), by way of which checking server the check data (NECO) of the at least one component (COMP1, COMP2, COMP3) are able to be checked.

In some embodiments, the automation installation additionally comprises detection means that are configured to detect at least one operating mode of the automation installation (MAN) and that are signal-connected to the checking server (CHESER).

In some embodiments, the checking server (CHESER) is designed and configured to check (CHAPP) the configuration of the at least one component (COMP1, COMP2, COMP3) applying signals from the detection means.

In some embodiments, the checking server (CHESER) is designed as a software module.

In some embodiments, the checking server (CHESER) is designed as a separate device.

In some embodiments, the automation installation includes, in addition to the at least one component (COMP1, COMP2, COMP3), at least one second or multiple components (COMP2, COMP3) each having a memory containing configuration data (NECO), and in which the at least one checking server (CHESER) is designed to check the configuration data (NECO) of the second or the multiple components (COMP2, COMP3).

In some embodiments, it is possible to use information when checking the second or the multiple additional components (COMP2, COMP3) of the automation installation in order to perform the check on the configuration data of the at least one component.

In some embodiments, the automation installation comprises a manufacturing installation (MAN).

### BRIEF DESCRIPTION OF THE DRAWINGS

The teachings of the present disclosure are explained in more detail below with reference to an exemplary embodiment indicated in the drawing. In the figures:

FIG. 1 shows a schematic basic sketch of a first exemplary embodiment of a manufacturing installation incorporating teachings of the present disclosure having three manufacturing components and a checking server for carrying out a method incorporating teachings of the present disclosure for checking a configuration; and

FIG. 2 shows a schematic basic sketch of a further exemplary embodiment of a manufacturing installation incorporating teachings of the present disclosure having three manufacturing components and a checking server for carrying out a further exemplary embodiment of a method incorporating teachings of the present disclosure for checking the configuration.

### DETAILED DESCRIPTION

In some embodiments, a method incorporating teachings of the present disclosure for checking a configuration of at least one component of an automation installation, configuration data of the at least one component are checked for admissibility by way of at least one checking server different from the at least one component. By virtue of the checking servers described herein, a configuration of the at least one component is thus not checked in such a way that the configuration data of this at least one component are subjected to a check only internally inside the at least one component, but rather the check on the at least one component takes place by way of a checking server different from the at least one component.

The check on the configuration of the at least one component is therefore not restricted just to the check on the at least one component itself on its own, but rather the checking server is able, as a component part of the automation installation different from the at least one component, to check the configuration data of the at least one component in such a way that the checking server also takes into consideration, in the check, further circumstances and information of the automation installation that are not located inside the at least one component. The configuration data may thus be checked depending on a context of the at least one component in which they are embedded. This situation makes it possible to ensure improved operational security and improved data security of the automation installation.

In some embodiments, the configuration data are checked depending on a current operating mode of the automation installation. In this development, the check on the configuration of the at least one component does not take place in isolation, but rather the check on the configuration of the at least one component takes into consideration a current operating mode of the automation installation. In some embodiments, the operating mode of the automation installation does not comprise an operating mode of the at least one component in isolation on its own, but rather the operating mode of the automation installation, in addition to the at least one component, additionally concerns one or more further components of the automation installation. The check on the configuration of the at least one component may thereby take into consideration context information in relation to the overall context of the automation installation.

Taking into consideration such an overall context of the automation installation makes it possible to detect operational security-critical or data security-critical configurations of the at least one component in certain operating modes and, potentially linked to these operating modes, in specific purposes that would not be problematic in other operating modes or purposes in terms of operational security and data security. Taking into consideration the operating mode of the automation installation therefore allows a more comprehensive check on the configuration of the at least one component than if the first component were just to be checked in isolation and without any context in terms of its configuration.

In the abovementioned development, the configuration data may be checked depending on a current operating mode. In some embodiments, the configuration data are checked depending on a future operating mode of the automation installation. In this development, the future operating mode may be cleared or initiated. Starting-up of a machine of the automation installation or starting-up of a technical process controlled or monitored by the automation installation, in particular performance of a manufacturing step, may thus be cleared or initiated depending on whether the configuration data are checked as being admissible depending on the current operating mode of the automation installation.

In some embodiments, the operating mode is a production mode and/or a maintenance mode and/or a test mode of the automation installation. In this development, the operating mode thus makes it possible to distinguish between the operating mode of the automation installation in a production mode and/or a maintenance mode and/or a test mode of the automation installation. Such a distinction makes it possible to permit a configuration of the at least one component in a test mode with parameters that are more critical for operational and/or information security than in a production mode.

On the contrary, for instance in a maintenance mode of the automation installation, not all configurations of the at least one component have to be permitted, since, in a maintenance mode, the first component does not have to have the ability to carry out all operating functions of the at least one component. Rather, the first component, in a maintenance configuration, may remain with a reduced functional scope compared to the production mode. As an alternative or in addition, maintenance-relevant functions of the at least one component may be enabled in a maintenance mode of the automation installation through the configuration, these functions not being necessary or even being operational security-critical or data security-critical in the production mode of the automation installation.

In some embodiments, the operating mode indicates an automated process of the automation installation, in particular one automated process from a set comprising at least one first production process and one second production process different from the first. Appropriately, in this development, the automation installation is a manufacturing installation. In this development, the configuration of the at least one component may therefore be checked in terms of the automated process of the automation installation, in particular depending on the respective production process of the manufacturing installation. In this development, context information in relation to the automated process of the automation installation may therefore be used to check the configuration of the at least one component.

In particular, production processes deliver information relevant to the configuration of components of automation installations: thus, in particular, manufacturing steps that require a certain temperature for manufacture, for instance joining steps or shaping steps, may require temperature limits for a heating device of the at least one component. In other production processes, however, other temperature limits may be expedient. In this development, taking into consideration the automated process of the automation installation therefore makes it possible to take into consideration process-related context information that may be used to check the configuration of the at least one component.

In some embodiments, the first and the second production process differ from one another in terms of a product of the first and the second production process and preferably in terms of product-related parameters of the first and the second production process. In particular when producing products, the information about the product to be manufactured may constitute relevant context information for a configuration of the at least one component of the automation installation. By way of example, different tolerances in terms of the dimensioning of component parts of the product may thus be admissible for different products, which entails different configurations of the at least one component of the automation installation. Different products may also be manufactured in each case at different temperatures, meaning that there are different temperature ranges or temperature intervals for the at least one component depending on the product to be manufactured. Such information may be taken into consideration in this development of the method according to the invention.

In some embodiments, the check on the configuration additionally takes place depending on an IT infrastructure of the automation installation and/or information about the at least one component of the automation installation and/or a result of a plausibility check on the configuration data of the at least one component and/or a positive list (whitelist) for admissible configuration data of the at least one component and/or a negative list (blacklist) for inadmissible configuration data of the at least one component and/or at least one cryptographic signature. In this development, further context information in relation to the automation installation may therefore be used and taken into consideration for the check on the configuration of the at least one component of the automation installation.

The automation installations described herein are designed to carry out one or more of the methods as described herein. The automation installation comprises at least one component having a memory containing configuration data and a checking server different from the at least one component, by way of which checking server the configuration data of the at least one component are able to be checked. In some embodiments, the checking server is designed to check the configuration data. The checking server may therefore check the configuration data of the at least one component or the checking server may provide criteria by way of which the configuration data of the at least one component are able to be checked, in particular by the component itself.

By virtue of the automation installation, it is therefore possible to check the configuration of the at least one component by way of the checking server different from the at least one component. By virtue of the checking server, context information in relation to the automation installation may therefore easily be taken into consideration when checking the configuration of the at least one component. The same advantages as already explained in connection with the methods incorporating teachings of the present disclosure arise in the automation installations.

In some embodiments, the automation installation has detection means configured to detect at least one operating mode of the automation installation, are signal-connected to the checking server. By virtue of the provided detection means, the checking server is therefore able to detect at least one operating mode of the automation installation and take it into consideration when checking the configuration of the at least one component.

In some embodiments, the checking server is designed and configured to check the at least one component by applying signals from the detection means. It is thereby easily possible as a result to take into consideration the operating mode of the automation installation when checking the configuration of the at least one component.

In some embodiments, the checking server is designed as a software module. In this development, it is therefore not necessary for the first component and the checking server to be physically and spatially separate from one another, as it were. The checking server and the first component may be implemented as mutually separate software modules, wherein the detection means are designed in particular as a data acquisition interface.

In some embodiments, the checking server is designed as a separate device that is not the same as the at least one component of the automation installation, that is to say is different from the at least one component. Appropriately, the automation installation has, in addition to the at least one component, at least one second or multiple further components each having a memory containing configuration data, wherein, in the automation installation, the checking server is designed to check the configuration data of the further component or components. In this development, the checking server may therefore perform the check on the configuration data of each of the components.

In this development, the further components may be taken into consideration when checking the configuration data of the at least one component. In exactly this way, information may be used when checking the second or the multiple additional components of the automation installation in order to perform the check on the configuration data of the at least one component. On the contrary, information in relation to the at least one component may also be used to check configuration data of the second or the multiple additional components. In this case, the further components may therefore be used as a source for additional context information when checking the configuration data.

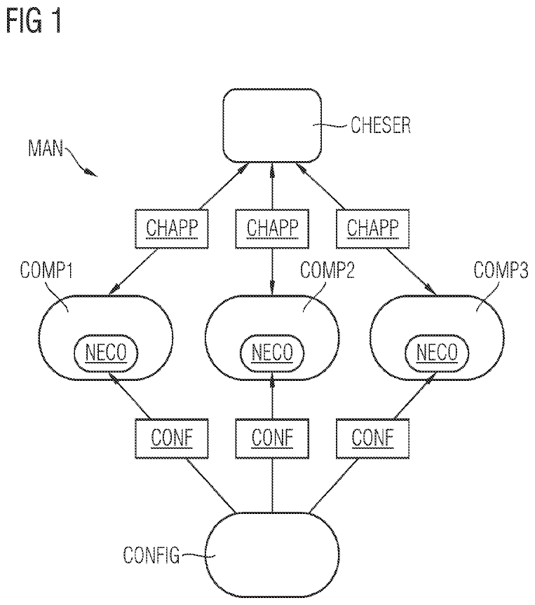

In some embodiments, the automation installation is a manufacturing installation. The installation illustrated in FIG. 1 is an automated manufacturing installation MAN and may also be referred to alternatively as an automation installation that is designed to manufacture a product. In the illustrated exemplary embodiment, the manufacturing installation MAN is used to manufacture a product in the form of a controller having a tailored geometry.

To this end, a circuit board having a wound geometry is populated by way of a first component COMP1. The circuit boards have a design that consists of flat parts that are not arranged flush or coplanar with one another, but rather the design is formed of flat parts that are arranged with their flat sides at 45-degree angles to one another. The populated circuit board is thermally bonded, hot-glued in the illustrated exemplary embodiment, to a housing part by way of a second component COMP2. The housing part is connected to a further housing part so as to form a housing provided with the circuit board by way of a third component COMP3.

In the manufacturing installation MAN, the three components COMP1, COMP2, COMP3 are configured by way of a configurator CONFIG. The configurator CONFIG is a software tool not belonging to the manufacturing installation MAN and that is configured to configure the components COMP1, COMP2, COMP3. To this end, the configurator CONFIG loads configuration data NECO into the components COMP1, COMP2, COMP3 in a configuration step CONF. As an alternative, the configurator CONFIG may also be a separate device or a user that/who manually loads configuration data NECO into the components COMP1, COMP2, COMP3 by way of a configuration step CONF. In other words, the configurator CONFIG transmits configuration data NECO to the components COMP1, COMP2, COMP3.

The components COMP1, COMP2, COMP3 initially hold the configuration data NECO in a preliminary evaluation memory that is used to check the configuration data NECO and from which the configuration data, following successful checking, enter a configuration data memory of the components COMP1, COMP2, COMP3, in which they are used to configure the components COMP1, COMP2, COMP3. The components COMP1, COMP2, COMP3 are configured for example when the manufacturing installation MAN is first set up, or else when a production sequence of the manufacturing installation is changed. The production sequence is changed in particular when a new, tailored product is manufactured using the manufacturing installation MAN, since the components COMP1, COMP2, COMP3 are then also adapted regularly with regard to their operating tasks and accordingly require new configuration data NECO for the adapted operating tasks.

In addition, it is often necessary to reconfigure the components COMP1, COMP2, COMP3 when the manufacturing installation MAN is changed from the production state to a maintenance state, since the components COMP1, COMP2, COMP3, in the maintenance state, first of all have an additional self-test functionality by way of which it is possible to diagnose a state of the components COMP1, COMP2, COMP3. In addition, production functions are blocked for the components COMP1, COMP2, COMP3, since it is not intended to manufacture a product in the maintenance state and for instance population without a circuit board first transferred to the first component COMP1 leads to a malfunction as far as the destruction of the first component COMP1.

The manufacturing installation MAN furthermore additionally has a test state in which various functions of the individual components COMP1, COMP2, COMP3 are tested. In the test state, the components COMP1, COMP2, COMP3 are provided with additional functionalities for test purposes, these not, or at least not all, being required in the production state of the manufacturing installation MAN.

The components COMP1, COMP2, COMP3 are configured in the manufacturing installation MAN by way of the configurator CONFIG. The manufacturing installation MAN additionally has a checking server CHESER that checks the configuration of the components COMP1, COMP2, COMP3. To this end, the checking server CHESER is signal-connected to each of the components COMP1, COMP2, COMP3 and is in communication with the components COMP1, COMP2, COMP3. The checking server CHESER has read access to the newly arrived configuration data NECO in the evaluation data memory of the components COMP1, COMP2, COMP3.

To this end, the checking server CHESER checks whether the configuration data NECO that the components COMP1, COMP2, COMP3 receive from the configurator CONFIG are admissible. The checking server CHESER is to this end signal-connected to a controller (not illustrated explicitly in the drawing) of the manufacturing installation MAN. The checking server CHESER receives, from the controller, the information as to the operating mode that the installation is in. The operating mode of the manufacturing installation MAN may be the production state, the maintenance state or the test state. The checking server CHESER then checks the configuration data NECO of the components COMP1, COMP2, COMP3 of the configurator depending on this operating mode of the manufacturing installation MAN.

The components COMP1, COMP2, COMP3 ultimately adopt the configuration data NECO for configuration purposes only when the checking server CHESER confirms the configuration data NECO as admissible. This check is performed upon each reconfiguration of the components COMP1, COMP2, COMP3.

The checking server CHESER additionally subjects the configuration data NECO of the components COMP1, COMP2, COMP3 to a check CHAPP on the basis of context information in relation to the respective product that the manufacturing installation MAN is currently manufacturing. For instance, a product in the form of a controller having a tailored geometry as described above requires different configuration data NECO than another product. This is because the angled geometry of the circuit board requires a larger reception space for reception of the circuit board by the second component COMP2 for connection to a housing part than a circuit board having a simple planar design. The second component COMP2 therefore has to be configured with configuration data NECO that provide such a larger reception space in the configuration. The checking server CHESER may take the geometric data required to check the reception space for instance from the spatial instructions for populating the circuit board of the first component COMP1 and in this regard use them as context for the check CHAPP on the configuration of the component COMP2.

Furthermore, the hot gluing of the circuit board to the housing part must not require such a large temperature input into the circuit board that electronic components with which the first component COMP1 populates the circuit board are impaired in terms of their function or destroyed due to the temperature input. As a result, the temperature requirements of the component parts of the circuit board define a temperature range within which the hot gluing of the circuit board to the housing part by way of the second component COMP2 is allowed to take place. The admissible temperature range of the second component COMP2 is derived here by the checking server CHESER from the population instructions of the first component and used to check CHAPP the configuration data NECO of the second component COMP2.

The checking server CHESER additionally comprises, for each of the components COMP1, COMP2, COMP3, a memory containing a list in the form of a whitelist for admissible configuration data, which is additionally compared with the configuration data NECO of the components COMP1, COMP2, COMP3. Only when the configuration data NECO of the components COMP1, COMP2, COMP3 are also contained in the whitelist are the configuration data NECO assessed as being admissible by the checking server CHESER. In this case, in further exemplary embodiments that are not illustrated separately, the configuration data NECO may also be compared with hash values of configuration data NECO contained in a whitelist instead of a direct comparison with the whitelist. In further exemplary embodiments that are not shown separately, the checking server CHESER may have a memory containing a blacklist of configuration data with which the configuration data NECO of the components COMP1, COMP2, COMP3 are compared. If the configuration data NECO appear on the blacklist, then the configuration data NECO are assessed as inadmissible.

In the illustrated exemplary embodiment, the checking server CHESER is a stand-alone device in the form of a computer that is introduced into the manufacturing installation MAN solely for the check CHAPP on configuration data NECO. In further exemplary embodiments that are not illustrated separately, the checking server CHESER may be implemented as a software module as a component part of a further system integrated in the manufacturing installation MAN, for example as a component part of a MES (=manufacturing execution system) or of a SCADA system.

The communication between the components COMP1, COMP2, COMP3 and the checking server CHESER is cryptographically protected in the illustrated exemplary embodiment, for example by way of a security protocol in the form of TLS or IPsec/IKEv2, or the transmitted messages are cryptographically protected by S/MIME, XML protection (XML Integrity, XML Encryption) or JSON protection (JSON Web Encryption, JSON Web Signature).

In the exemplary embodiment illustrated in FIG. 1, the components COMP1, COMP2, COMP3 do not make a decision about admissible changes of configuration themselves, but rather the configuration is adopted in each case only when the configuration is classified, that is to say accepted, as admissible by the checking server CHESER.

In some embodiments, the checking server CHESER incorporates the following further criteria into its check CHAPP with regard to the admissibility of the configuration data NECO: information about the respective components COMP1, COMP2, COMP3 themselves and/or knowledge about the IT infrastructure of the manufacturing installation MAN and/or knowledge about admissible projections of the manufacturing installation MAN and/or authorized version states of software installed on the components COMP1, COMP2, COMP3.

The checking server CHESER may additionally place and check specific conditions with regard to the integrity and authenticity of the configuration data NECO, independently of the detailed content checks or plausibility checks on the admissible configuration data NECO. These include for example checking a cryptographic MAC value or a signature of the configuration data NECO or of the configurator CONFIG: only when the MAC value of the signature of the configurator CONFIG is valid is the configuration either accepted or permitted for a content check CHAPP on the configuration data NECO. The procedure may also be adopted here whereby certain configurations are allowed or forbidden depending on the authority that issued a signature.

The reaction of the checking CHESER server to incorrect configuration data NECO including errors in the authenticity check on the configuration data NECO takes place, in the illustrated exemplary embodiment, by way of information regarding lack of clearance of the configuration data NECO by the checking server CHESER. The components COMP1, COMP2, COMP3 are accordingly not authorized to adopt the configuration data NECO.

In some embodiments, the check CHAPP on the configuration data NECO may also be carried out by way of the checking server CHESER such that the checking server CHESER transmits more detailed information about the check result to the components COMP1, COMP2, COMP3, for example which parts of the configuration data NECO are correct and which are erroneous or inadmissible or how greatly the configuration data NECO deviate from the fully admissible configuration data NECO. In some embodiments, the checking server CHESER informs further systems/components, which may then react accordingly to the check result.

Depending on the check CHAPP performed by the checking server CHESER, the components COMP1, COMP2, COMP3 may behave differently: in the simplest case, starting of the component COMP1, COMP2, COMP3 is allowed when the configuration data NECO are considered to be admissible as a result of the check CHAPP performed by the checking server CHESER or the starting of the components COMP1, COMP2, COMP3 is prevented when the configuration data NECO are assessed as being inadmissible by the checking server CHESER.

Based on the result of the check CHAPP performed by the checking server CHESER, the components COMP1, COMP2, COMP3 may also enable or forbid certain functionalities of the respective components COMP1, COMP2, COMP3, in particular the components COMP1, COMP2, COMP3 may also allow or forbid more detailed specific functionalities of the components COMP1, COMP2, COMP3 based on a finely granular result.

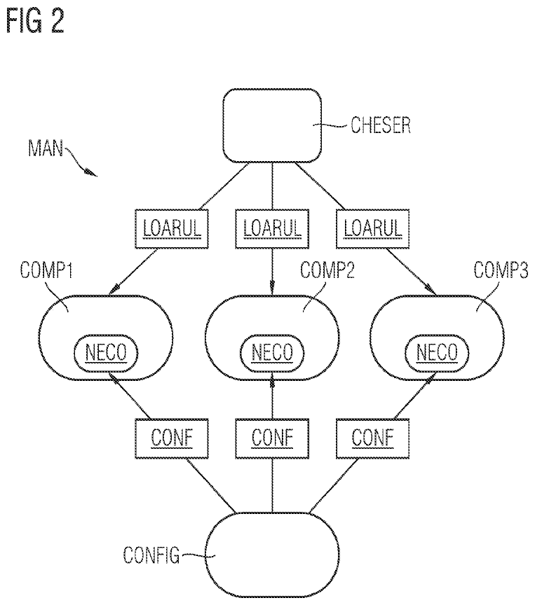

In a further exemplary embodiment illustrated in FIG. 2, which incidentally corresponds to the first exemplary embodiment, the check CHAPP, although it is performed by way of the checking server CHESER, is not performed by this itself. In this exemplary embodiment, the checking server CHESER instead defines the check criteria and transmits these check criteria to the components COMP1, COMP2, COMP3 for the check, in which the checking server loads the check criteria into the components COMP1, COMP2, COMP3 by way of a loading process LOARUL and does not however perform the check itself. The reactions of the components COMP1, COMP2, COMP3 to the check result are the same as those in the first variant.

In some embodiments, the components COMP1, COMP2, COMP3 distinguish between simple configuration data NECO that are able to be checked locally on the component COMP1, COMP2, COMP3, for instance a configuration of their own hardware. On the other hand, configuration data NECO that are critical to the operational security of the manufacturing installation MAN are however forwarded from the component COMP1, COMP2, COMP3 in each case to the checking server CHESER, and the check is carried out by the checking server CHESER.

What is claimed is:

1. A method for checking a configuration of at least one component of an automation installation, the method comprising:
checking configuration data of the at least one component for admissibility by using a checking server different from the at least one component.

2. The method as claimed in claim 1, wherein checking the configuration data includes checking a current operating mode of the automation installation.

3. The method as claimed in either of claim 1, wherein the operating mode is a production mode and/or a maintenance mode and/or a test mode.

4. The method as claimed in claim 1, wherein the operating mode indicates an automated process of the automation installation from a set of a first production process or a second production process different from the first.

5. The method as claimed in claim 4, wherein at least the first and the second production process differ from one another in terms of a product of the first and second production processes.

6. The method as claimed in claim 1, wherein checking on the configuration depends on at least one of:
an IT infrastructure of the automation installation,
information about the at least one component of the automation installation,
a result of a plausibility check on the configuration data of the at least one component,
a whitelist for admissible configuration data of the at least one component,
a blacklist for inadmissible configuration data of the at least one component, and/or
at least one cryptographic signature.

7. The method as claimed in claim 1, wherein the automation installation further comprises at least one second or multiple components; and
the method further comprises checking configuration data of the second or the multiple components are for admissibility using the at least one checking server; and
using information in the check on the second or the multiple additional components of the automation installation when the configuration data of the at least one component are checked.

8. An automation installation comprising:
at least one component having a memory storing configuration data; and
a checking server different from the at least one component;
wherein the checking server checks the configuration data of the at least one component for admissibility.

9. The automation installation as claimed in claim 1, further comprising detection means to detect at least one operating mode of the automation installation;
wherein the detection means are signal-connected to the checking server.

10. The automation installation as claimed in claim 1, wherein the checking server checks a configuration of the at least one component by applying signals from the detection means.

11. The automation installation as claimed in claim 1, herein the checking server comprises a software module.

12. The automation installation as claimed in claim 1, in which the checking server comprises a separate device.

13. The automation installation as claimed in claim 1, further comprising at least one second or multiple components each having a memory containing configuration data; and
wherein the at least one checking server checks the configuration data of the second or the multiple components.

14. The automation installation as claimed in claim 1, wherein it is possible to use information when checking the second or the multiple additional components to perform the check on the configuration data of the at least one component.

15. The automation installation as claimed in claim 1, further comprising a manufacturing installation.
